(19) United States
(12) Patent Application Publication
(10) Pub. No.: US 2006/0161676 A1
(43) Pub. Date: Jul. 20, 2006

(54) Apparatus for IP streaming capable of smoothing multimedia stream

(75) Inventors: Sang-Mo Hong, Goyang-si (KR); Chang-Sup Shim, Seoul (KR); Jun-Ho Koh, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/332,521

(22) Filed: Jan. 13, 2006

(30) Foreign Application Priority Data
Jan. 18, 2005 (KR) 2005-4676

(51) Int. Cl. G06F 15/16

(52) U.S. Cl. 709/231

(57) ABSTRACT

An apparatus for IP streaming capable of smoothing a multimedia stream is disclosed. The apparatus transmits real-time broadcast through an Internet protocol (IP) network and reduces transmission loss by lowering the influence derived from jitters in an IP network having a burst characteristic. The apparatus is capable of smoothing a multimedia stream in a multimedia stream service outputting data through buffering based on a packetized elementary stream packet unit, which is easy to synchronize voice with video and suitable for the real-time multimedia stream service.

### CLAIM OF PRIORITY

This application claims priority to an application entitled “Apparatus for IP Streaming Capable of Smoothing Multimedia Stream,” filed in the Korean Intellectual Property Office on Jan. 18, 2005 and assigned Ser. No. 2005-4676, the contents of which are incorporated herein by reference.

### BACKGROUND OF THE INVENTION

1. Field of the Invention

The present invention relates to an apparatus for transmitting real-time broadcast via an Internet protocol (IP) network, and more particularly to an IP streaming transmission apparatus for reducing transmission loss by lowering the influence derived from jitters in an IP network having a burst characteristic.

2. Description of the Related Art

An Internet Protocol (IP) streaming service provides transmission/reproduction of mass multimedia data such as video/audio according to the user's demand in real time. The IP streaming service has been developing rapidly due to a high increase in user demands for multimedia services. As such, it has become the most desirable service for constructing future interactive Internet TV services, such as a video conference service, and a video phone service, as well as a real-time transmission service of simple video or audio data.

In the IP streaming service, a user visits a web server and clicks multimedia position information, and the web server transmits the multimedia position information to a web browser of the user. At this time, the web browser serves as a streaming player and sends the multimedia position information to the streaming player. Then, the streaming player reads the transmitted multimedia position information and connects to a streaming server so as to request a real-time transmission of corresponding multimedia data. Thereafter, the streaming server transmits the multimedia data to the streaming player in real time, thereby providing an IP streaming service.

A web server belonging to an Internet broadcasting company operates a multimedia home page and provides data position information. Thus, it is enough if the user is simply equipped with a web browser and a streaming player capable of reproducing multimedia data in real time. This multimedia streaming service is provided through an IP network, and the process of streaming data in the IP network is vital in providing the multimedia streaming service. In particular, data loss due to delay and jitter in the IP network may cause serious problems in the multimedia streaming service.

Generally, the IP network has a problem in keeping a quality of service (QoS) for real-time broadcasting through the IP network due to a burst transmission characteristic of IP data. In particular, the IP data have jitters at the receiver according to the burst transmission characteristic. Buffers are provided in order to reduce the jitters. However, data transmission delay occurs due to the sizes of the buffers.

FIGS. 1A and 1B are graphs illustrating an IP streaming pattern of an IP streamer in a typical IP network.

In FIGS. 1A and 1B, a horizontal axis shows packet numbers of data, and a vertical axis shows time intervals for receiver arrival of packets. In particular, FIG. 1A is a graph illustrating the time intervals for arrival of IP packets reaching a receiver. FIG. 1B is a graph obtained by expanding small parts of the time intervals for the arrival of the IP packets shown in FIG. 1A.

As shown in FIG. 1A, about 1800 IP packets repeatedly reach the receiver in an uniform pattern with a time interval of approximately 0.002 seconds after a long idle time of 0.6 seconds. As such, if several burst data share one link with each other when these multimedia data are transmitted over the IP network, a loss or delay occurring probability becomes high even though an average bandwidth is narrow. For example, on the assumption that high definition (HD)-level TV broadcast service having an average data rate of 20 Mbps is provided through a 100 Mbps-link, IP streaming patterns are transmitted at a data rate of above 50 to 60 Mbps for an initial predetermined time interval (a time interval in which about 1800 packets reach the receiver between long idle time intervals) and then not transmitted for a relatively longer idle time interval of about 0.6 seconds, so that an average data rate of 20 Mbps is maintained. At this time, although the average data rate is 20 Mbps, a bandwidth cannot be limited to 20 Mbps and is allocated with at least 50 Mbps in order to prepare for the worst case.

Accordingly, IP streams having such a burst transmission characteristic forces the receiver to employ buffers, the capacity of which is greater than the average data rate. In addition, IP streams having such a burst transmission characteristic at a specific time, so that it is possible to cause data loss, which may not be caused according to the average data rate, due to the shortage of a bandwidth.

Meanwhile, to address the above problem in the IP network, a method of performing smoothing and streaming according to I frames, P frames, and B frames when motion picture expert group (MPEG) data are transmitted and a method of performing smoothing and streaming based on a group of pictures (GOP) are suggested in order to reduce loss and delay due to a burst characteristic of these multimedia streaming data. However, these methods, which may be used when multimedia data compressed through the MPEG are directly transmitted as MPEG elementary streams, are focused on seamless voice rather than the synchronization between audio and video.

Accordingly, the conventional methods are not suitable for a real-time multimedia stream service such as a broadcast service requiring a precise synchronization between voice and video. Therefore, there is a need for smoothing an IP stream, which makes it easy to synchronize voice with video, and is also suitable for a real-time multimedia stream service.

### SUMMARY OF THE INVENTION

Accordingly, the present invention has been made to solve the above-mentioned problems occurring in the prior art and provides additional advantages, by providing an Internet protocol (IP) streaming apparatus capable of smoothing a multimedia stream in a multimedia stream service outputting data through buffering based on a packetized elementary stream packet unit, which is easy to synchronize voice with video and suitable for the real-time multimedia stream service.

In one embodiment, there is provided an apparatus for Internet protocol streaming, which can smooth a multimedia stream, the apparatus including an elementary stream encoder for providing an elementary stream (ES) by receiving multimedia data, a packetized elementary stream (PES) packetizer for packetizing the elementary stream provided from the elementary stream encoder into a plurality of packetized elementary stream packets, a transport stream (TS) packetizer for performing transport stream packetizing by receiving packetized elementary stream packets from the packetized elementary stream packetizer, a clock for providing time stamps for synchronization to the packetized elementary stream packetizer and the transport stream packetizer, a first switch for receiving the transport stream packet output from the transport stream packetizer and switching and delivering the transport stream packet, first and second buffers for storing transport stream packets delivered from the first switch, a second switch for switching to one of the first buffer and the second buffer and delivering the transport stream packet stored in a corresponding buffer, an IP encapsulator for performing Internet protocol encapsulating with respect to the transport stream packet delivered through the second switch, and a controller for controlling the first switch and the second switch by receiving packetized elementary stream (PES) packetizing information from the packetized elementary stream packetizer.

### BRIEF DESCRIPTION OF THE DRAWINGS

The above features and advantages of the present invention will be more apparent from the following detailed description taken in conjunction with the accompanying drawings, in which:

FIGS. 1A and 1B are graphs for explaining an IP streaming pattern of an IP streamer in the typical IP network;

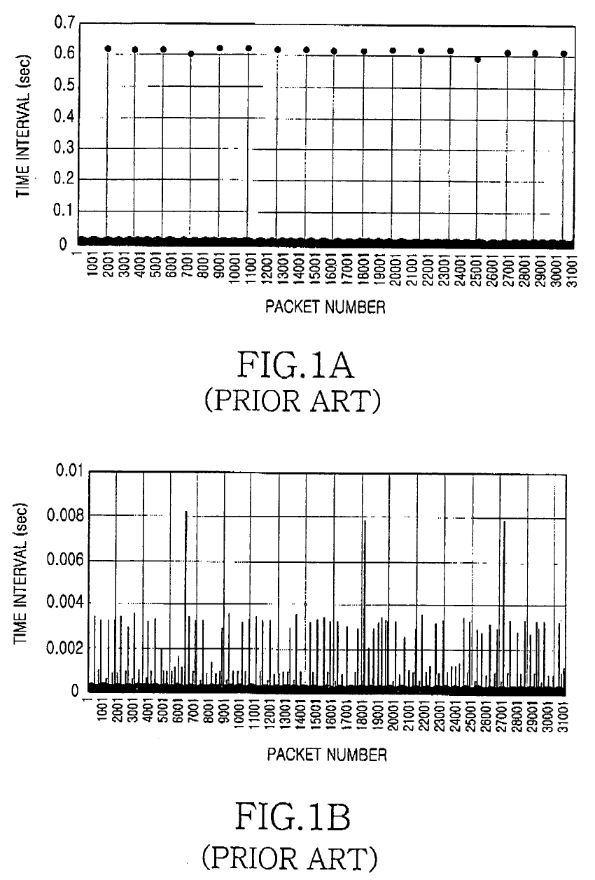

FIGS. 2A and 2B illustrate smoothed data through the conventional method for smoothing frame intervals;

FIGS. 3A and 3B illustrate smoothed data through the conventional method for smoothing a GOP interval;

FIG. 4 is a block diagram illustrating the structure of an IP streaming apparatus capable of smoothing a multimedia stream according to the present invention; and

FIGS. 5A and 5B illustrate IP multimedia stream transmission patterns in an IP streaming apparatus capable of smoothing a multimedia stream according to the present invention.

### DETAILED DESCRIPTION

Hereinafter, an embodiment of the present invention will be described in detail with reference to the accompanying drawings. Note that the same or similar components in drawings are designated by the same reference numerals as far as possible although they are shown in different drawings. For the purposes of clarity and simplicity, a detailed description of known functions and configurations incorporated herein will be omitted as it may make the subject matter of the present invention rather unclear.

A multimedia stream employed in the present invention is a MPEG-2 stream. Briefly, a description about the MPEG-2 will be first given. The MPEG-2 employs both an intra-frame and an inter-frame, and three-type video frames including an Intra (I) frame, a bi-directional (B) frame, and a Predicted (P) frame (constructing a group of pictures; GOP) are used as bit streams.

The I frame coded in the form of the intra-frame controls frames while compressing overall frames as if the Motion-JPEG format or the Digital Video format. Accordingly, a stream including only I frames has an advantage in view of an editing operation such as a scrubbing interface, a quick search and cut editing function, and an exact editing based on a frame and has the lowest compression rate.

In addition, the P frame (a predicted frame) has information different from information about a previous frame, the B frame (bi-directional frame) has information predicted based on information obtained from a previous frame and a next frame, and these P and B frames have sizes smaller than the size of the I frame.

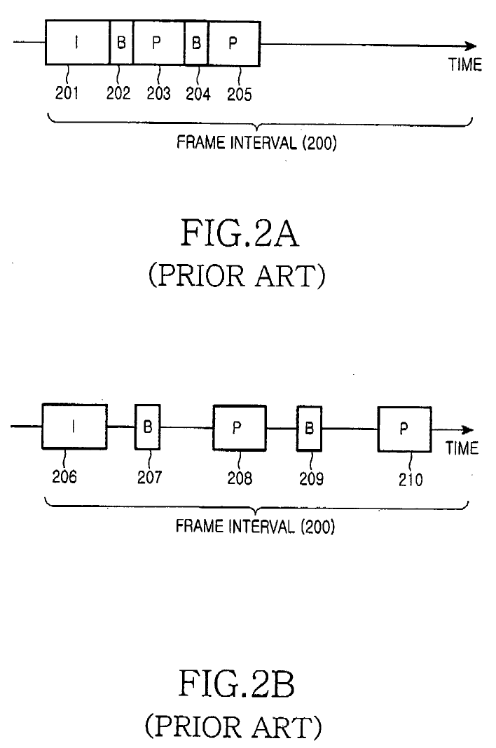

FIGS. 2A and 2B illustrate smoothed data through the conventional method for smoothing frame intervals.

As shown in FIG. 2A, in frame transmission before smoothing, an I frame 201, B frames 202 and 204, and P frames 203 and 205 are concentrated on a front part of a frame interval 200 to be transmitted. Accordingly, a data rate is rapidly raised in the front part of the frame interval 200, and a data rate is lowered in a rear part of the frame interval 200. As described above, since a burst characteristic of data transmission exists, smoothing is performed based on a frame as shown in FIG. 2B. In particular, through the smoothing based on a frame, the I frame 206, the B frames 207 and 209, and the P frames 208 and 210 to be transmitted are distributed within the frame interval 200 in a uniform ratio. Although a data rate is raised in the I frame having a large size even in this case, smoothing is achieved throughout the overall frame interval because all transmission frames within the frame interval 200 are not concentrated and transmitted differently from FIG. 2A.

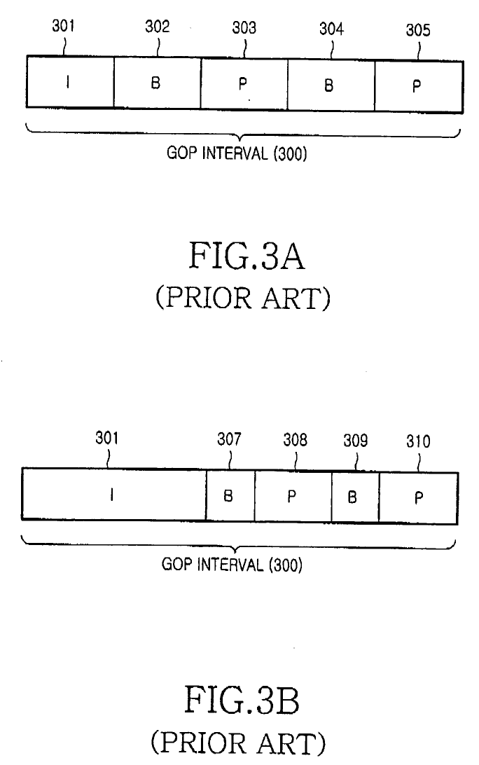

FIGS. 3A and 3B illustrate smoothed data through another conventional method of smoothing a GOP interval.

As shown in FIG. 3A, in frame transmission before smoothing, an I frame 301, B frames 302 and 304, and P frames 303 and 305 to be transmitted in one frame interval 300 are transmitted with a uniform interval in a GOP interval 200. Accordingly, a data rate is rapidly raised when the I frame is transmitted, and a data rate is lowered when the B or P frames are transmitted. As described above, since a burst characteristic of data transmission is shown, smoothing based on a GOP unit is achieved, as shown in FIG. 3B.

Referring to FIG. 3B, the I frame 306, the B frames 307 and 309, and the P frames 308 and 310 to be transmitted are classified according to data sizes within the GOP interval 300. The I frame 306 having a large data size is allocated with a great amount of data transmission time, thereby lowering a data rate. In contrast, the B frames having relatively small sizes are allocated with a less amount of data transmission time, thereby raising a data rate. Accordingly, smoothing is achieved throughout the GOP interval 300.

However, the above smoothing method is a technique applied to an initial video conference as shown in FIGS. 2A to 3B, thus not suitable for a real-time multimedia stream service, such as digital broadcast essentially requiring synchronization between video and voice. As a result, an additional device and a precise control for synchronization between video and voice are required.

Therefore, the present invention provides an apparatus for smoothing a multimedia stream capable of enabling a smoothed frame transmission while synchronizing voice with video with a minimum delay. In particular, the present invention provides a transfer apparatus for smoothing IP stream patterns such that a wide transmission bandwidth is not instantaneously occupied when an IP streamer performs streaming. According to the teachings of the present invention, an apparatus for smoothing a multimedia stream according to packetized elementary streams (PESs) is on the assumption that PES is employed as a basic unit for transmission.

Hereinafter, a description about the PES will be given. The MPEG-2 stream includes a program stream (PS) or a transport stream (TS). The PS is formed by multiplexing a plurality of elementary streams (ESs), and the TS is formed by multiplexing ESs, PSs, or other TSs.

The ESs is formed as a sequence of PES packets having the same stream identifiers. These ESs are divided into a plurality of packets and then sequentially arranged in order to be transmitted in the IP network. The PES is re-formed by packetizing the ESs, which are sequentially arranged, with a predetermined length.

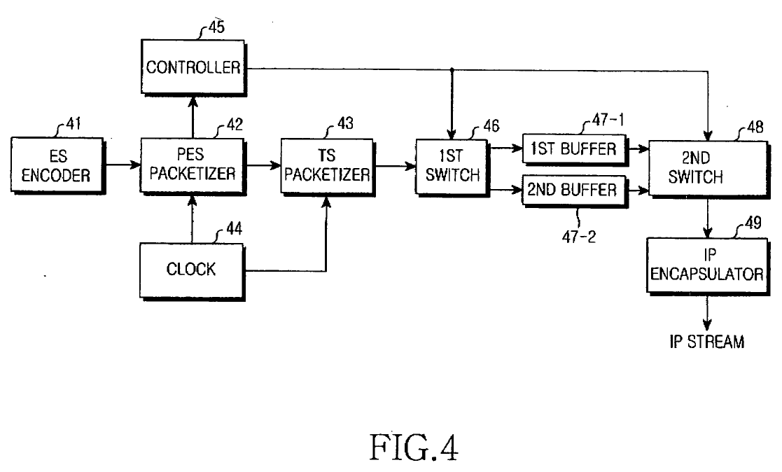

FIG. 4 is a block diagram illustrating the structure of an IP streaming apparatus capable of smoothing a multimedia stream according to the present invention.

As shown, the inventive IP streaming apparatus includes: an elementary stream encoder 41 for receiving multimedia data and providing elementary streams; a PES packetizer 42 for packetizing the elementary streams from the elementary stream encoder 41 into a plurality of PES packets; a TS packetizer 43 for TS-packetizing the PES packets from the PES packetizer 42; a clock 44 for providing time stamp values for synchronization to the PES packetizer 42 and the TS packetizer 43; a first switch 46 for performing a switching operation under the control of a controller 45 by receiving the TS packets output from the TS packetizer 43 based on a PES packet unit; first and second buffers 47-1 and 47-2 for storing TS packets switched by the first switch 46; a second switch 48 for performing a switching operation according to the control of the controller 45 such that TS packets stored in the first buffer 47-1 or the second buffer 47-2 are delivered; an IP encapsulator 49 for IP-streaming the TS packets switched through the second switch 48; and a controller 45 for controlling the first switch 46 and the second switch 48 by receiving the PES packetizing information from the PES packetizer 42.

In operation, the elementary stream encoder 41 receives multimedia data and encodes the multimedia data into elementary streams to be output, and the PES packetizer 42 outputs a plurality of PESs by packetizing the output elementary stream. Here, since a time reference is broken in the procedure of creating PESs, time stamps such as a presentation time stamp (PTS) and a decoding time stamp (DTS) from the clock 44 are inserted in order to perform synchronization at a receiver, so information about the time reference is provided within the PES.

An MPEG-2 system requires two types of synchronization. One is clock synchronization between a data signal source and a decoder, and the other is synchronization for presentation of several multiplexed elementary streams. Herein, the synchronization according to the presentation is the synchronization for presentation of several multiplexed elementary streams. To this end, the PTS and the DTS are provided.

In addition, the TS packetizer 43 TS-packetizes a PES by receiving the PES from the PES packetizer 42. Information about the PTS and the DTS are provided from the clock 44, so the PES is output according to information about the PTS and the DTS.

The two buffers 47-1 and 47-2 are provided in order to smooth the TS packet, which is output from the TS packetizer 43, based on a PES packet unit in order to transmit the TS packet. In this case, the sizes of the two buffers 47-1 and 47-2 are determined according to the size of the PES packet.

The first switch 46 is controlled according to packetization information in the PES packetizer 42 in order to input the TS packet, which is output from the TS packetizer 43, to each buffer 47-1 or 47-2 based on the PES packet unit.

The second buffer 48 is controlled according to the packetization information in the PES packetizer 42 in order to receive stored TS packets based on the PES packet unit from each buffer 47-1 or 47-2.

As described above, the first buffer 47-1 and the second buffer 47-2 sequentially operate, and, when one buffer receives a packet, the other buffer outputs a packet. Accordingly, the controller 45 controls the first switch 46 and the second switch 48 so as to operate alternately. In addition, the TS packet from the second switch 48 is IP-encapsulated into an IP stream to be output.

As described above, when multimedia data are streamed, multimedia data are smoothed by means of the IP streaming apparatus capable of smoothing a multimedia stream according to the present invention. Herein, the smoothing denotes a scheme in which data occupying a wide bandwidth for an instant are divided by a predetermined time interval and transmitted. The present invention considers synchronization and such a smoothing scheme with respect to multimedia data. In other words, a PES packet header including PTS information and DTS information for synchronization must previously transmit to a receiver with a predetermined time interval. However, since it is difficult to distinguish between the header and the payload of the PES based on an MPEG-2 TS packet, the output buffers 47-1 and 47-1 are constructed based on a PES packet unit such that the TS packetizer 43 of the IP streamer can output TS packets with a predetermined time interval. Therefore, according to the present invention, a PES packet is transmitted during a time interval for buffering one PES packet while smoothing is performed based on a PES packet, and synchronization is achieved through PTS information and DTS information included in the header of the transmitted PES packet.

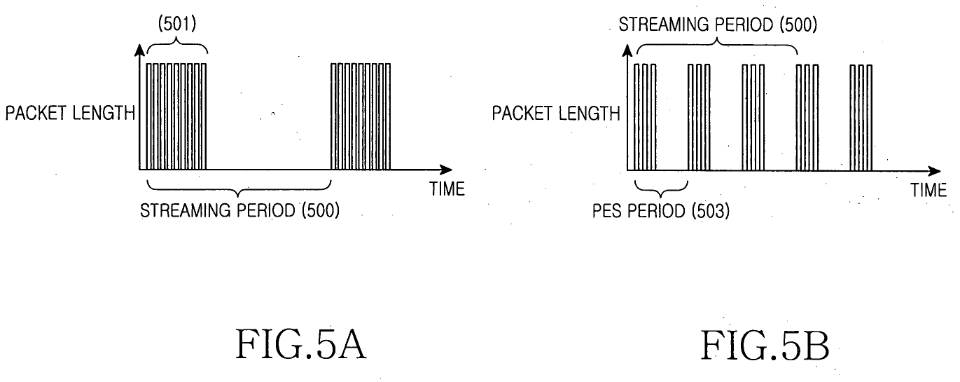

FIGS. 5A and 5B illustrate IP multimedia stream transmission patterns in the inventive IP streaming apparatus.

In the conventional IP multimedia stream transmission pattern shown in FIG. 5A, IP multimedia streams 501 are temporarily concentrated and transmitted in a streaming period 500 and are not transmitted in a remaining streaming period.

An IP multimedia stream transmission pattern in the IP streaming apparatus according to the present invention shown in FIG. 5B is transmitted during a PES period 503 divided from the streaming period 500 shown in FIG. 5A. It would be obvious to those skilled in the art that the IP multimedia stream transmission pattern shown in FIG. 5B is more remarkably smoothed as compared with the IP multimedia stream transmission pattern shown in FIG. 5A.

As described above, according to the present invention, it is possible to remarkably reduce loss and delay due to a burst characteristic according to IP network transmission and maintain data synchronization in a receiver when real-time multimedia are transmitted through the IP network. In addition, according to the present invention, it is possible to improve QoS for an IP multimedia stream service. It is noted that the method according to the present invention described above can be realized through program and stored on storage media, such as a CD ROM, a RAM, a floppy disk, a hard disk, and an optical magnetic disk, in a format which can be read by a computer.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. An apparatus for Internet protocol streaming, comprising:
an encoder for providing an elementary stream (ES) from received multimedia data;
a packetized elementary stream (PES) packetizer for packetizing the elementary stream into a plurality of packetized elementary stream packets;
a transport stream (TS) packetizer for performing a transport stream packetizing on the packetized elementary stream packets;
a clock for providing time stamps for synchronization to the packetized elementary stream packetizer and the transport stream packetizer;
a first switch for performing a switching operation on the transport stream packet output from the transport stream packetizer;
first and second buffers for storing the transport stream packets delivered from the first switch;
a second switch for switching to one of the first buffer and the second buffer and for outputting the transport stream packet stored in a corresponding buffer
an IP encapsulator for performing Internet protocol encapsulating with respect to the transport stream packet delivered through the second switch; and
a controller for controlling the first switch and the second switch by receiving packetized elementary stream (PES) packetizing information from the packetized elementary stream packetizer.

2. The apparatus as claimed in claim 1, wherein the first buffer and the second buffer are capable of storing one packetized elementary stream (PES) packet.

3. The apparatus as claimed in claim 2, wherein the apparatus outputs a packet with a predetermined time interval by outputting a packet based on a packetized elementary stream (PES) unit.

4. The apparatus as claimed in claim 1, wherein the time stamps provided in the clock are a presentation time stamp (PTS) and a decoding time stamp (DTS).

5. The apparatus as claimed in claim 4, wherein the presentation time stamp (PTS) and the decoding time stamp (DTS) are stored in a header of the packetized elementary stream (PES) packet.

6. The apparatus as claimed in claim 1, wherein the controller controls the first switch and the second switch to operate alternatively, so that, when one buffer receives a packet, the other buffer outputs a packet.

7. An apparatus for Internet protocol streaming, comprising:
an encoder for providing an elementary stream (ES) from received multimedia data;
a packetized elementary stream (PES) packetizer for packetizing the elementary stream into a plurality of packetized elementary stream packets;
a transport stream (TS) packetizer for performing a transport stream packetizing on the packetized elementary stream packets;
first and second buffers for storing the transport stream packets;
a first switch for switching to one of the first buffer and the second buffer and for outputting the transport stream packet stored in a corresponding buffer
an IP encapsulator for performing Internet protocol encapsulating with respect to the transport stream packet output from the switch; and
a controller for controlling the switch using packetized elementary stream (PES) packetizing information from the packetized elementary stream packetizer.

8. The apparatus as claimed in claim 7, further comprising a clock for providing time stamps for synchronization to the packetized elementary stream packetizer and the transport stream packetizer.

9. The apparatus as claimed in claim 7, further comprising a second switch for performing a switching operation on the transport stream packet output from the transport stream packetizer.

10. The apparatus as claimed in claim 7, wherein the first buffer and the second buffer are capable of storing one packetized elementary stream (PES) packet.

11. The apparatus as claimed in claim 10, wherein the apparatus outputs a packet at a predetermined time interval by outputting a packet based on a packetized elementary stream (PES) unit.

12. The apparatus as claimed in claim 8, wherein the time stamps provided in the clock are a presentation time stamp (PTS) and a decoding time stamp (DTS).

13. The apparatus as claimed in claim 12, wherein the presentation time stamp (PTS) and the decoding time stamp (DTS) are stored in a header of the packetized elementary stream (PES) packet.

14. The apparatus as claimed in claim 9, wherein the controller controls the first switch and the second switch to operate alternatively, so that, when one buffer receives a packet, the other buffer outputs a packet.
